(19) United States
(12) Patent Application Publication
(10) Pub. No.: US 2020/0057175 A1
(43) Pub. Date: Feb. 20, 2020

(54) WEATHER DEPENDENT ENERGY OUTPUT FORECASTING

(71) Applicant: NEC Laboratories America, Inc., Princetion, NJ (US)

(72) Inventors: Yue Zhang, Pullman, WA (US); Chenrui Jin, Cupertino, CA (US); Ratnesh Sharma, Fremont, CA (US)

(21) Appl. No.: 16/519,509

(22) Filed: Jul. 23, 2019

Related U.S. Application Data
(60) Provisional application No. 62/719,158, filed on Aug. 17, 2018.

(51) Int. Cl. G01W 1/10; G01W 1/12; G01W 1/06; G06N 3/04; H02J 3/38; G06K 9/62

(52) U.S. Cl. CPC G01W 1/10; G01W 1/12; G06K 9/6257; G06N 3/049; H02J 3/383; G01W 1/06

(57) ABSTRACT

Systems and methods for photovoltaic (PV) output forecasting are provided. The methods include determining whether a weather condition that indicates a first forecasting model to have a greater accuracy than a deep learning-based forecasting model is detected in weather data for a predetermined time span. The method also includes forecasting PV output, by a processing device, using the first forecasting model in response to a determination that the weather condition is detected in the weather data for the predetermined time span. The method further includes predicting PV output using the deep learning-based forecasting model in response to a determination that the weather condition is not detected in the weather data for the predetermined time span.

### RELATED APPLICATION INFORMATION

This application claims priority to U.S. Provisional Patent Application No. 62/719,158, filed on Aug. 17, 2018, incorporated herein by reference herein its entirety.

### BACKGROUND

### Technical Field

The present invention relates to photovoltaic forecasting and more particularly to systems and methods for predicting photovoltaic output.

### Description of the Related Art

The integration of photovoltaic (PV) generation into the power grid has been growing rapidly over the past decades. In recent years, PV accounts for an increasingly significant percentage of total newly added electricity capacity in the U.S. Despite the environmental benefits of PV power, the inherent variability of PV power has a growing impact on both the PV owners and system operators.

### SUMMARY

According to an aspect of the present invention, a method is provided for photovoltaic (PV) output forecasting. The method includes include determining whether a weather condition that indicates a first forecasting model to have a greater accuracy than a deep learning-based forecasting model is detected in weather data for a predetermined time span. The method also includes forecasting PV output, by a processing device, using the first forecasting model in response to a determination that the weather condition is detected in the weather data for the predetermined time span. The method further includes predicting PV output using the deep learning-based forecasting model in response to a determination that the weather condition is not detected in the weather data for the predetermined time span.

According to another aspect of the present invention, a system is provided for photovoltaic (PV) output forecasting. The system includes a processor device operatively coupled to a memory device. The processor device determines whether a weather condition that indicates a first forecasting model to have a greater accuracy than a deep learning-based forecasting model is detected in weather data for a predetermined time span. The processor device forecasts PV output using the first forecasting model in response to a determination that the weather condition is detected in the weather data for the predetermined time span. The processor device predicts PV output using the deep learning-based forecasting model in response to a determination that the weather condition is not detected in the weather data for the predetermined time span.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a generalized diagram of a neural network, in accordance with an embodiment of the present invention;

FIG. 2 is a diagram of an artificial neural network (ANN) architecture, in accordance with an embodiment of the present invention;

FIG. 3 is a block diagram illustrating an architecture for implementing day-ahead photovoltaic output forecasting, in accordance with the present invention;

FIG. 4 is a block diagram illustrating a forecasting model using a long-short-term-memory (LSTM) network, in accordance with an embodiment of the present invention;

FIG. 5 is a block diagram illustrating a LSTM cell architecture, in accordance with an embodiment of the present invention;

FIG. 6 is a block diagram illustrating a location of a photovoltaic (PV) site and a North American Mesoscale (NAM) location, in accordance with an embodiment of the present invention;

FIG. 7 is a block diagram illustrating PV output and associated features over one testing week, in accordance with an embodiment of the present invention;

FIG. 8 is a block diagram illustrating selection of features using root mean squared Euclidean distance difference (RMSEDD) for all input features, in accordance with an embodiment of the present invention;

FIG. 9 is a table illustrating the impact of feature selection on forecasting accuracy, in accordance with an embodiment of the present invention;

FIG. 10 is a block diagram illustrating impact of the training data size on the average forecasting error, in accordance with an embodiment of the present invention;

FIG. 11 is a block diagram illustrating impact of the training data size on the standard deviation of forecasting error, in accordance with an embodiment of the present invention;

FIG. 12 is a flow diagram illustrating an example method for photovoltaic output forecasting, in accordance with an embodiment of the present invention; and

FIG. 13 is block diagram of a system for photovoltaic output forecasting, in accordance with an embodiment of the present invention.

### DETAILED DESCRIPTION OF PREFERRED EMBODIMENTS

In accordance with embodiments of the present invention, systems and methods are provided for weather dependent energy output forecasting, such as, for example, day-ahead photovoltaic output forecasting. The systems and methods provide a hybrid forecasting model with a combination of Long-short-term-memory network (LSTM) and persistent method (PM) to provide energy output forecasting (for example, day-ahead photovoltaic (PV) output forecasting) at predetermined intervals (for example, 15-minute-interval) with high accuracy and robustness.

The systems and methods improve the accuracy of PV generation forecasting providing benefits for both the PV owner and the power system. The example embodiments use deep learning processes for time series forecasting and apply deep learning to PV generation forecasting. The example embodiments provide a hybrid forecasting model for PV forecasting that retains the advantages of the persistent method in certain scenarios. From the PV owner's perspective, the example embodiments can apply PV forecasting to help owners to reduce miss bidding costs and increase revenue.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

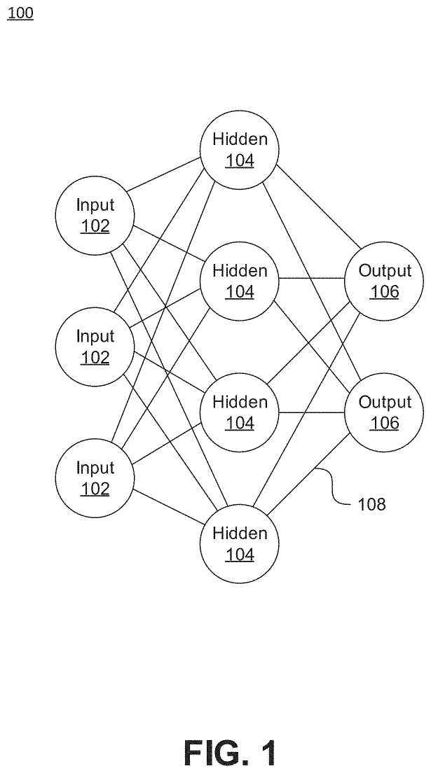

Referring now in detail to the figures in which like numerals represent the same or similar elements and initially to FIG. 1, a generalized diagram of a neural network 100 is shown.

An artificial neural network (ANN) is an information processing system that is inspired by biological nervous systems, such as the brain. The key element of ANNs is the structure of the information processing system, which includes many highly interconnected processing elements (called “neurons”) working in parallel to solve specific problems. ANNs are furthermore trained in-use, with learning that involves adjustments to weights that exist between the neurons. An ANN is configured for a specific application, such as pattern recognition or data classification, through such a learning process.

ANNs demonstrate an ability to derive meaning from complicated or imprecise data and can be used to extract patterns and detect trends that are too complex to be detected by humans or other computer-based systems. The structure of a neural network generally has input neurons 102 that provide information to one or more “hidden” neurons 104. Connections 108 between the input neurons 102 and hidden neurons 104 are weighted and these weighted inputs are then processed by the hidden neurons 104 according to some function in the hidden neurons 104, with weighted connections 108 between the layers. There can be any number of layers of hidden neurons 104, and as well as neurons that perform different functions. There exist different neural network structures as well, such as convolutional neural network, maxout network, etc. Finally, a set of output neurons 106 accepts and processes weighted input from the last set of hidden neurons 104.

This represents a “feed-forward” computation, where information propagates from input neurons 102 to the output neurons 106. Upon completion of a feed-forward computation, the output is compared to a desired output available from training data. The error relative to the training data is then processed in “feed-back” computation, where the hidden neurons 104 and input neurons 102 receive information regarding the error propagating backward from the output neurons 106. Once the backward error propagation has been completed, weight updates are performed, with the weighted connections 108 being updated to account for the received error. This represents just one variety of ANN.

Example embodiments of the present invention can implement the ANN 100 to provide a long-short-term-memory network (LSTM) for photovoltaic forecasting. The ANN can be used in a hybrid PV forecasting system, that includes both persistent and LSTM-NN training as the training model of a PV forecasting engine.

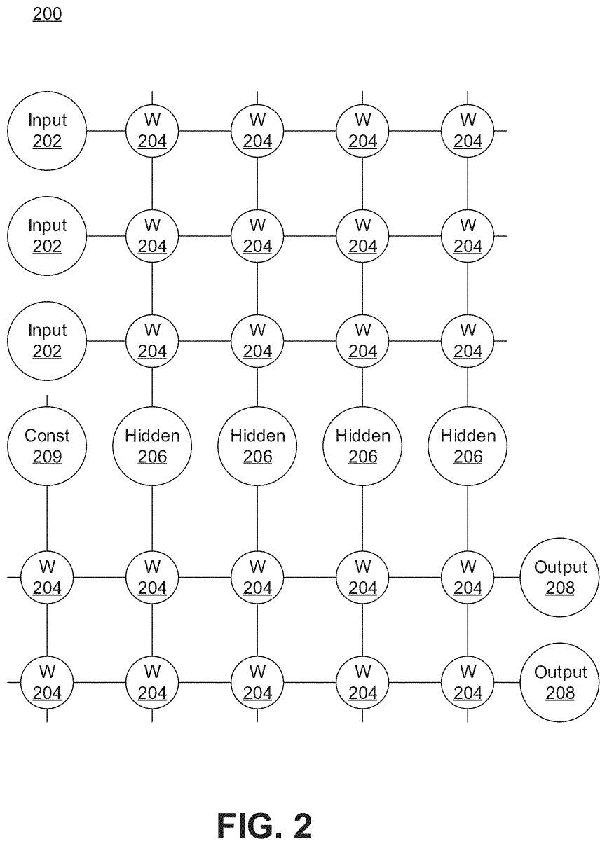

Referring now to the drawings in which like numerals represent the same or similar elements and initially to FIG. 2, an artificial neural network (ANN) architecture 200 is shown. It should be understood that the present architecture is purely exemplary and that other architectures or types of neural network may be used instead. The ANN embodiment described herein is included with the intent of illustrating general principles of neural network computation at a high level of generality and should not be construed as limiting in any way.

Furthermore, the layers of neurons described below and the weights connecting them are described in a general manner and can be replaced by any type of neural network layers with any appropriate degree or type of interconnectivity. For example, layers can include convolutional layers, pooling layers, fully connected layers, stopmax layers, or any other appropriate type of neural network layer. Furthermore, layers can be added or removed as needed and the weights can be omitted for more complicated forms of interconnection.

During feed-forward operation, a set of input neurons 202 each provide an input signal in parallel to a respective row of weights 204. In the hardware embodiment described herein, the weights 204 each have a respective settable value, such that a weight output passes from the weight 204 to a respective hidden neuron 206 to represent the weighted input to the hidden neuron 206. In software embodiments, the weights 204 may simply be represented as coefficient values that are multiplied against the relevant signals. The signals from each weight adds column-wise and flows to a hidden neuron 206.

The hidden neurons 206 use the signals from the array of weights 204 to perform some calculation. The hidden neurons 206 then output a signal of their own to another array of weights 204. This array performs in the same way, with a column of weights 204 receiving a signal from their respective hidden neuron 206 to produce a weighted signal output that adds row-wise and is provided to the output neuron 208.

It should be understood that any number of these stages may be implemented, by interposing additional layers of arrays and hidden neurons 206. It should also be noted that some neurons may be constant neurons 209, which provide a constant output to the array. The constant neurons 209 can be present among the input neurons 202 and/or hidden neurons 206 and are only used during feed-forward operation.

During back propagation, the output neurons 208 provide a signal back across the array of weights 204. The output layer compares the generated network response to training data and computes an error. The error signal can be made proportional to the error value. In this example, a row of weights 204 receives a signal from a respective output neuron 208 in parallel and produces an output which adds column-wise to provide an input to hidden neurons 206. The hidden neurons 206 combine the weighted feedback signal with a derivative of its feed-forward calculation and stores an error value before outputting a feedback signal to its respective column of weights 204. This back-propagation travels through the entire network 200 until all hidden neurons 206 and the input neurons 202 have stored an error value.

During weight updates, the stored error values are used to update the settable values of the weights 204. In this manner the weights 204 can be trained to adapt the neural network 200 to errors in its processing. It should be noted that the three modes of operation, feed forward, back propagation, and weight update, do not overlap with one another.

The example embodiments can incorporate the ANN architecture 200 to implement different forecasting systems based on temporal weather conditions, such as a long-short-term-memory neural network (LSTM-NN) architecture for time series forecasting that includes a recurrent architecture and memory units and a persistent model that performs with a higher degree of accuracy for predictions based on consecutive sunny days. A sunny day can be defined as a weather condition in which the cloud cover does not exceed a predetermined maximum cloud cover (for example, for a predetermined maximum time). Alternatively, a sunny day can be defined as a weather condition in which an average cloud cover remains beneath a predetermined maximum cloud cover.

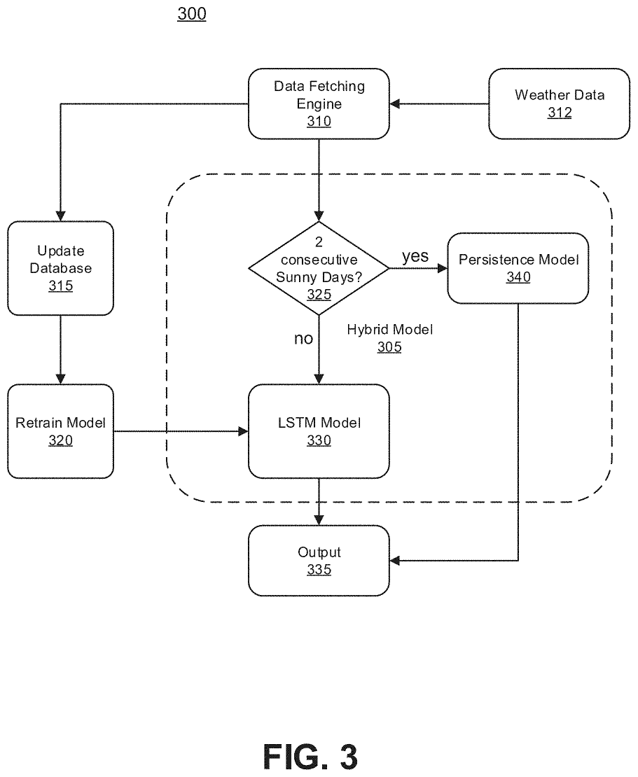

FIG. 3 is a block diagram illustrating an architecture 300 for implementing (for example, day-ahead) photovoltaic output forecasting, in accordance with example embodiments.

According to example embodiments, weather data 312 from numerical weather prediction (NWP) can be utilized to train forecasting models to generate (for example, day-ahead) photovoltaic (PV) power prediction at predetermined (for example, 15-minute) intervals. In other example embodiments the processes can be applied to wind energy forecasting. Although example embodiments are described with respect to a particular forecast range (for example, a day ahead) and with respect to particular weather conditions (two consecutive sunny days), the embodiments can be used for different forecast ranges and weather conditions. For example, the weather condition can be identified based on an error rate of the first forecasting model exceeding an error rate of the deep learning-based forecasting model whenever the weather condition occurs. The forecast range can be any predetermined (or selected) time span.

The example embodiments include a real time data query and storage mechanism that integrates the fetched NWP data 312 with historical PV generation data to train a PV forecasting engine. A hybrid PV forecasting process 305, using both persistent (340) and long-short-term-memory neural network (LSTM-NN) (330) training can be used as the training model of the PV forecasting engine. LSTM-NN 330 architecture is more suitable for time series forecasting due to its recurrent architecture and memory units, while persistent model 340 performs best for consecutive sunny day predictions. Using weather data 312 from NWP model, the example embodiments provide a hybrid PV forecasting method that outperforms many other PV forecasting methods regarding prediction accuracy and robustness.

According to example embodiments, deep learning architectures used for photovoltaic (PV) output forecasting are analyzed. These include solar radiation fed into a deep convolutional neural network (DCNN), a one-step-ahead deep believe neural network (DBNN) model developed with inputs including panel temperature, ambiance temperature, accumulated energy, and irradiance, a DBNN model for day-ahead forecasting at 30-minute-interval, a Long-Short-Term-Memory neural network (LSTM-NN) for day-ahead PV forecasting and past power as input to predict one step ahead forecasting. The example embodiments of the hybrid model 305 provide enhancements to deep learning architectures. These include incorporating predicted weather data from numerical weather prediction (NWP) models as inputs. The example embodiments provide day ahead higher resolution forecasting results that can be particularly useful for energy system applications, such as the demand charge management of batteries. The example embodiments combine different processes, methods and analyses to capture the trend in future PV power generation.

An architecture of the example embodiments is illustrated in FIG. 3. The weather data 312 is fetched (by data fetching engine 310) from the local weather bureau and input to a hybrid model 305. These data 312 are utilized to determine whether a target day is a similarly sunny day as a day before the target day (for example, two consecutive sunny days?) 325. If yes, a persistence model 340 can be used to produce the prediction (output 335). Otherwise, (for example, two consecutive sunny days? 325, decision is no) the data 312 will be feed into a trained LSTM model 330 to generate the day-ahead forecast (output 335). The newly fetched weather data 312 and recorded power data can be used to update the dataset (for example, update database 315). After an accumulation of time, the model 330 will be retrained 320 based on the updated datasets 315.

According to example embodiments, data fetching engine 310 aims to fetch published forecast weather data 312 for the target day. For example, the forecast weather data 312 can be fetched (retrieved, collected, etc.) from the North American Mesoscale (NAM) numerical weather prediction model developed by National Oceanic Atmospheric Administration (NOAA). The NAM model produces hourly weather prediction on a grid resolution of 12 km×12 km over the North American area up to 36 hours. NOAA publishes weather prediction values four times each day at the following time points: 00 Coordinated Universal Time (UTC), 06 UTC, 12 UTC and 18 UTC. For testing locations, in instances in which day ahead PV forecast is desired before 12 PST, data published at 06 UTC each day can be used. The weather prediction data can also be data cleansed and features can be selected. According to example embodiments, (for example, five) related weather features can be selected, including temperature (K), relative humidity (%), wind speed (m/s), total cloud cover (%) and solar radiation flux density watts per square meter (W/m²), etc.

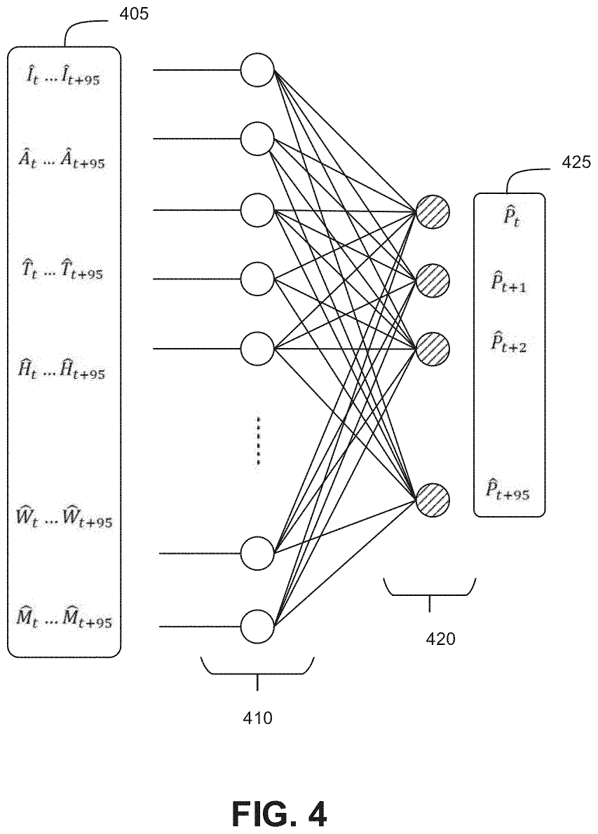

FIG. 4 is a block diagram illustrating a forecasting model using an LSTM network, in accordance with example embodiments.

As illustrated in FIG. 4, the LSTM Model 330 (as described and illustrated with respect to FIG. 3, herein above) will produce the day-ahead PV prediction 425 (\hat{P}_{t+j,} j=0, . . . , N−1¹) using the fetched weather prediction data with particular weather parameters 405: for example, solar radiation (I), temperature (T), relative humidity (H), wind speed (W), time index data (M) and calculated solar zenith angle data (A), (Îₜ₊ⱼ, \hat{T}ₜ₊ⱼ, Ĥₜ₊ⱼ, Ŵₜ₊ⱼ, \hat{M}ₜ₊ⱼ, Âₜ₊ⱼ, j=0, . . . , N−1). t indicates a time stamp of the data point and N is the total prediction time steps. For a prediction range of 24 hours and prediction resolution of 15 minute, the total prediction time step is 96. The model can be built, for example, with Keras python package with one LSTM layer 410 and one dense layer 420. The parameters for the trained model also include a weather type (and corresponding reduction rate, in brackets) as follows: mist (reduction rate 78.58%), clouds (reduction rate 79.53%), rain (reduction rate 52.74%), haze (reduction rate 78.98%) and fog (reduction rate 54.46%). According to example embodiment, an Adam optimizer compiles the Keras model and mean squared error is chosen for loss function. The number of epochs to train the model is 35, and the activation function for the output layer is sigmoid function.

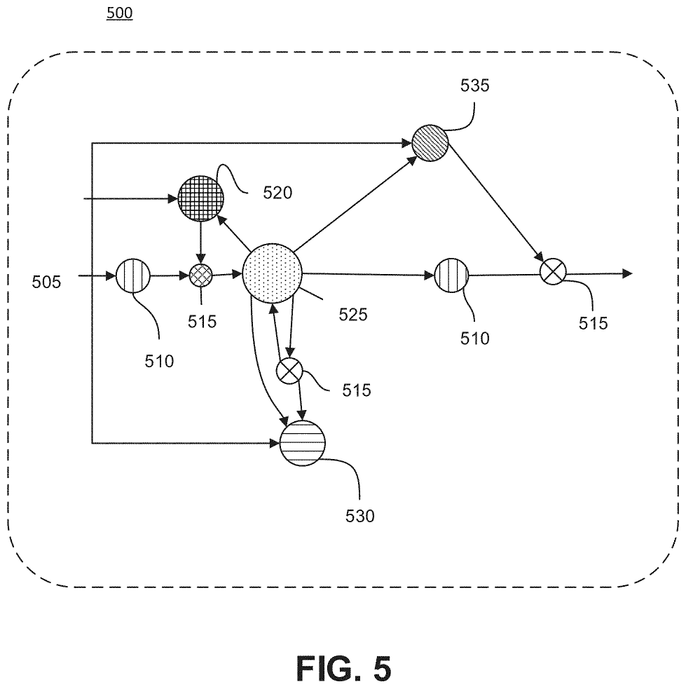

FIG. 5 is a block diagram illustrating an LSTM cell architecture 500, in accordance with example embodiments.

The LSTM layer 410 is built by the LSTM unit 500, whose structure (cell architecture) is presented in FIG. 5. The main components of the LSTM unit are forget 530, input 520 and output gates 535. Summer junctions 515 are also incorporated into the architecture. Each of the gates determines the portion of information to forget, to update and to output through a σ function 510, where the output varies from 0 to 1. The inputs include current sample Xₜ (505) and the output from the three gates (Yₜ₋₁, Cₜ₋₁, Oₜ₋₁) in the previous iteration. Cₜ (525) is the cell state at time stamp t and Yₜ is an output from the LSTM cell. The output of the architecture is Yₜ (540). The detailed output updating process can be implemented based on Eqns. 3 to 7, where W_{k=1, . . . , 11} and B_{l=1,2,3,4} are the weights and bias.

Fₜ=σ(W₁Xₜ+W₂Yₜ₋₁+W₃Cₜ₋₁+B₁) (1)

Iₜ=σ(W₄Xₜ+W₅Yₜ₋₁+W₆Cₜ₋₁+B₂) (2)

Oₜ=σ(W₇Xₜ+W₈Yₜ₋₁+W₉Cₜ₋₁+B₃ (3)

Cₜ=FₜCₜ₋₁+Iₜ tan h(W₁₀Xₜ+W₁₁Yₜ₋₁+B₄) (4)

Yₜ=Oₜ tan h(Cₜ) (5).

Before the utilization of LSTM model 330, example embodiments train the LSTM model 330 with a training process that includes two parts, feature selection, and model tuning. Even though one of the advantages of deep learning is extracting important features automatically, application of feature selection in PV forecasting is still critical. In many instances, datasets are limited to one PV site, and it can be uneconomical to wait several years to build a large training set. The example embodiments utilize precise feature selection to enable the systems to solve the prediction problem using fewer data and fewer computing resources. According to an example embodiment, the root mean squared Euclidean distance difference (RMSEDD) is utilized to help select important features for the training set. RMSEDD for each feature vi can be defined as:

$$\begin{matrix}{RMSEDD}_{i} = \frac{\sqrt{{\sum }_{{d}^{′} = d}^{N} {\sum }_{d = 1}^{{d}^{′}} {( ED ( p , d , {d}^{′} ) - ED ( {v}_{i} , d , {d}^{′} ) )}^{2}}}{\frac{1}{2} N ( N - 1 )} . & ( 6 ) \\ ED ( x , d , {d}^{′} ) = \sqrt{{\sum }_{t = 1}^{06} {( {x}_{t}^{( d )} - {x}_{t}^{( {d}^{′} )} )}^{2}} . & ( 7 )\end{matrix}$$

Where, ED (x, d, d′) measures the Euclidean distance (ED) between day d and d′ based on normalized variables x, which include normalized iₜₕ feature vᵢ and normalized PV output p. t indicates the data point and N indicates the number of training days.

The optimal parameters for the LSTM forecasting model 330 can be selected via an iterative process. The model tuning of the LSTM forecasting model 330 is done by an iterative process, for example, trial-and-error.

Persistence model (PM) 340 utilizes the observed value of day d as the forecasts for day d+1. This forecasting process has an outstanding performance when the output from day d+1 is very similar to day d, which usually happens for two consecutive sunny days. To take advantage of persistence model 340 under that circumstance, the example embodiments incorporate a mechanism to determine whether that condition will happen for the target day. Since NOAA NAM model is very accurate to predict sunny weather, if the ED(Î, d, d+1) is less than a certain threshold, day d+1 and d are most likely two sunny days, the hybrid prediction model 305 switches between persistence model 340 and LSTM forecasting model 330 by examining the ED (Î, d, d+1) value at the beginning of each day.

The example embodiments can utilize several commonly used error measurements to measure the prediction accuracy including daily normalized root-mean-square deviation (nRMSE), normalized mean-absolute-error (nMAE) and bias error (BIAS) for each predicted data point. Those error measurements are defined as:

$$\begin{matrix}nRMSE = \frac{100}{{P}_{C}} \sqrt{{\sum }_{t = 1}^{96} {( {\hat{P}}_{t} - {P}_{t} )}^{2}} & ( 8 ) \\ nMAE = \frac{100}{{P}_{C}} {\sum }_{t = 1}^{96} {\hat{\vert P}}_{t} - {P}_{t} \vert & ( 9 ) \\ BIAS = {\hat{P}}_{t} - {P}_{t} , & ( 10 )\end{matrix}$$

where, PC is the capacity of the PV site, for example, maximum PV power output. P\hat{ }t and Pt are the forecasted and recorded PV output at data point t. For day-head forecast with a 15-minute resolution, there are 96 data points for each testing day. If the nRMSE is much higher than the nMAE, the prediction tends to have a larger deviation. The BIAS can be used to measure the actual error distribution.

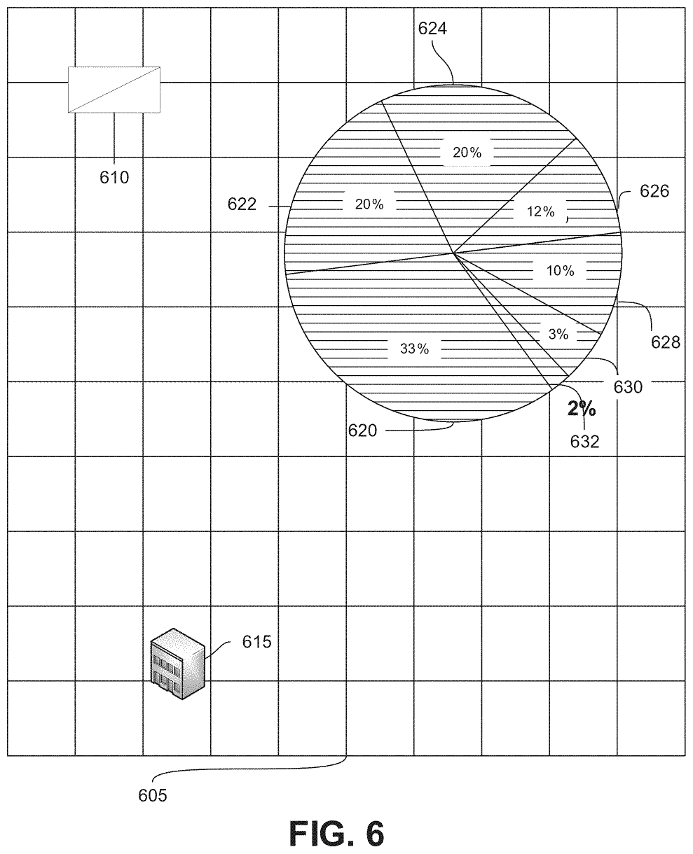

FIG. 6 is a block diagram illustrating a location of a PV site and NAM location, in accordance with example embodiments.

The example embodiments have been tested at a site, for example a 6.41 kW PV site at Cupertino, Calif., USA (37.32N,122.01 W), which includes twenty-one 305 W SPR-305-WHT model PV panels. The power data was recorded at 15-minute time interval from Jul. 1, 2015 to Dec. 31, 2016. The position of the test PV site 610 and the nearest NAM grid 615 is plotted in FIG. 6 (on a grid 605). The weather type distribution is plotted in the right corner of FIG. 6 (these include clear 620, mist 622, clouds 624, rain 626, haze 628, fog 630 and other 632. Sunny (clear 620) (33%) is the most common weather type for the test location. Assuming the average PV output during the clear day is 100%, the average power outputs under other weather types are mist (reduction rate 78.58%), clouds (reduction rate 79.53%), rain (reduction rate 52.74%), haze (reduction rate 78.98%) and fog (reduction rate 54.46%). The average power outputs are reduced to as low as 52.74% (during rain); and the power output under those weather will be challenging to predict.

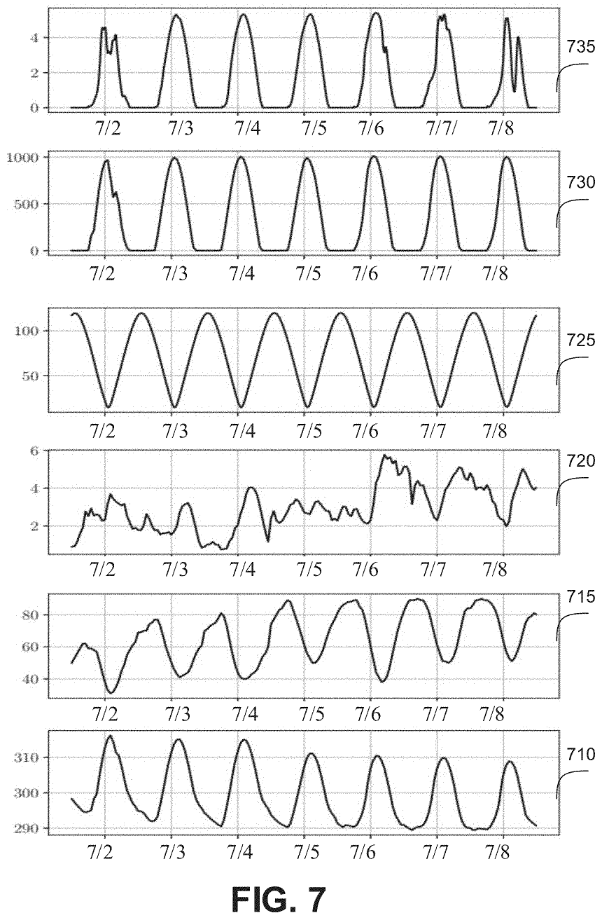

FIG. 7 is a block diagram illustrating PV output and associated features over one testing week, in accordance with example embodiments.

The PV output and associated features over one testing week (July 2 to July 8) are presented in FIG. 7. In addition to features from NOAA (for example, temperature (K) 710, relative humidity (%) 715, wind speed (m/s) 720, total cloud cover (%) (not shown in FIG. 7) and solar radiation flux density (W/m²) 730), solar zenith angle 725 (and polarized minute and day index utilized, not shown in FIG. 7) are also examined. A corresponding power output 735 is also provided.

The performance of the LSTM model 330 is influenced by several factors including input features, epochs, and size of training data. The impacts of these factors are simulated and analyzed as follows:

Impact of feature selection: The DC (direct current) power output of PV is directly impacted by temperature and radiation as shown the following equation:

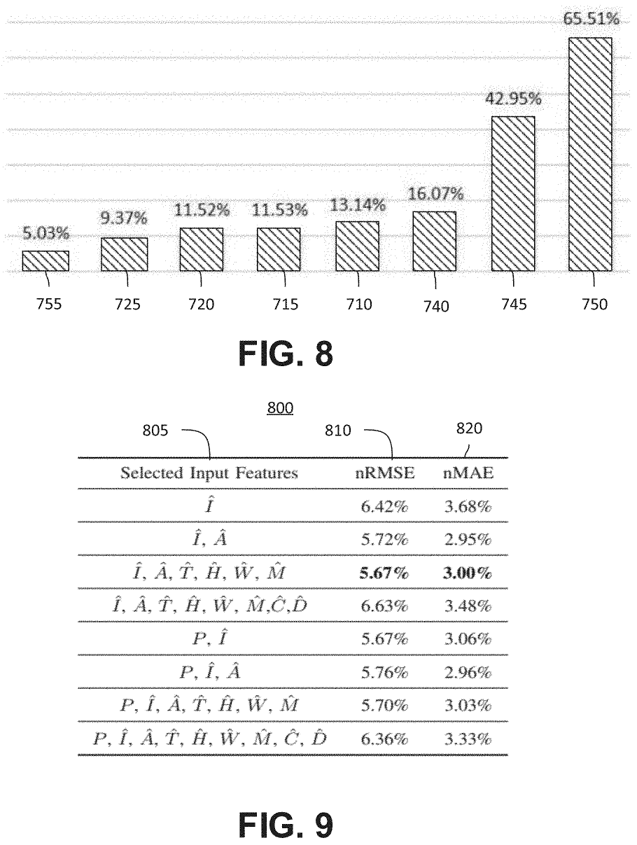

P_{DC,t}=ηSIₜ[1−0.005(Tₜ+25)] (11).

Where, P_{DC,t} is maximum DC power output (kW) at time t, S is the PV panel area (m²), Iₜ is the solar radiation on top of the panel at time t, Tₜ is the ambient temperature (° C.) at time t and η is the PV conversion efficiency (%). In ideal condition (with no wind or cloud cover near the PV panel), the system can calculate the PV generation by using the environmental temperature and solar radiation. However, other parameters also have indirect impacts on the PV power output and the relationship is usually non-linear. For example, higher wind speed may cool down the panel and cloud cover may reduce the radiation reaching the panel. The systems therefore incorporate analysis of weather features in training the LSTM model as described below with respect to FIG. 8.

FIG. 8 is a block diagram illustrating use of RMSEDD for selection of input features, in accordance with example embodiments.

To select suitable input features, the RMSEDD for all available features are first calculated as shown in FIG. 8 (for solar radiation 755, solar zenith angle 725, temperature 710, relative humidity 715, wind speed 720, polarized day and minute index 740, and total cloud 745). The lower RMSEDD value indicates that feature has a more similar trend as the PV output. As seen from FIG. 8, highly related features like solar radiation 755 and solar zenith angle 725 have RMSEDD values that are less than 10%; while less relevant features such as polarized day index 750 has a RMSEDD value larger than 60%.

Based on the RMSEDD for each feature, different input feature combinations have been tested. The combination ranges from one input feature with lowest RMSEDD to all available features. The testing results are presented in Table. 800, shown in FIG. 9.

FIG. 9 is a table 800 illustrating the impact of feature selection on forecasting accuracy, in accordance with example embodiments.

As shown in table 800, which compares selected input features 805 with nRMSE 810 and nMAE 820, the performance of both extreme cases (all or a single feature) is less effective than selecting a particular combination of features. For example, a single input feature has an nRMSE 810 of 6.42% and nMAE 820 of 3.68%. The extreme cases have higher nRMSE 810 and nMAE 820 values than those combinations of feature. Therefore, utilizing only the most relevant feature or all available features as inputs does not train the best forecasting model; while features that have less than 20% RMSEDD build the best combination. Since the previous days' PV power outputs are utilized as a training input feature in literature, the example embodiments also test the impacting of involving the previous days' PV power outputs are utilized as a training input feature. As seen from the results, the impact of involving previous day's PV generation as an input has limited impact on the model performance, except for the model using only solar radiation as selected input feature. Due to the high trans-day volatility nature of PV generation, previous day's power output has limited relationship with the target day's output.

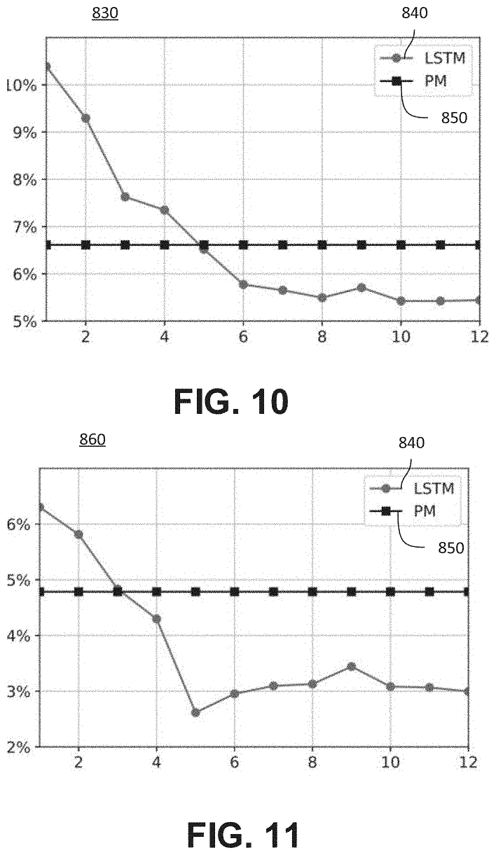

FIG. 10 is a block diagram 830 illustrating impact of the training data size on the average forecasting error, in accordance with example embodiments.

As can be seen in FIG. 10, block diagram 830 provides a graph of training data set size (x-axis) against percentage forecasting error (y-axis). Plot points with circular markers represent output 840 of LSTM model 330 while plot points with square markers represent the output 850 of the persistence model 340. As training data size increases, the forecasting error in (the output 840 of) LSTM model 330 decreases, while the training data size increase has negligible (or no) effect on the output 850 of the persistence model 340.

FIG. 11 is a block diagram 860 illustrating impact of the training data size on the standard deviation (std) of forecasting error, in accordance with example embodiments.

As can be seen in FIG. 11, as training data size (x-axis) increases, the standard deviation (y-axis) in (the output 840 of) LSTM model 330 decreases, while the training data size increase has negligible (or no) effect on the standard deviation of the output 850 of the persistence model 340.

Impact of dataset updating: the example embodiments address one of the challenges of using deep learning approach for PV forecast, which is insufficient training set. PV owners usually do not store historical PV generation data of long period of time. Data may be available for the past few years or even few months. The example embodiments quantify the impact of the training set size. The example embodiments use a model retraining engine 320 with larger training sets to achieve more accurate and stable forecasting results. After cumulating one-month data, the model will be retrained (via retain model 320) with the updated database 315 (referring back to FIG. 3). As shown in FIGS. 10 and 11, which show LSTM 330 and PM 340 performance after each has been trained by half year data, the example embodiments perform significantly better than the benchmark persistence model 340. In real world applications, PV sites with accumulated (for example, a half-year) data can utilize the processes described herein and can gain better forecasting results in instances in which the PV site collects the new data and uses the retrain engine 320.

According to example embodiments, a hybrid day-ahead PV output forecast model was tested at a 6.41 kW PV site at Cupertino, Calif. The forecast model used in that test was consistent with example embodiments and included a combination of persistence model 340 and LSTM learning model 330. Through data analysis based on historical PV generation, PV sites are determined to have similar output patterns for a predetermined sequence (for example, two consecutive sunny days) and the PV forecast based on the PV output of an earlier portion of the predetermined sequence (for example, the previous sunny day) is very accurate for a later portion of the predetermined sequence (for example, a following sunny day). Therefore, when such weather condition is predicted, the example embodiments utilize a persistence model 340 to forecast the PV output. The weather condition prediction process has an observed overall accuracy of approximately 80%.

For other weather conditions, the example embodiments utilize a LSTM (sub) model 330. LSTM models 330 can take multiples features as inputs and find inner relations of the multiple features with PV output. The example embodiments can be applied in real life applications in which training data is limited for PV forecasting applications. To the challenge of limited training data, the example embodiments use feature selection metrics to assist in selecting relevant features for training the LSTM model 330. The example embodiments remove the requirement for a minimal training set. According to example embodiments, the hybrid model can be validated over a predetermined (for example, three month) period, and can thereafter effectively generate periodic (for example, 15-minute-interval) PV output forecasting for a predetermined period (for example, the next 24 hours). The example embodiments improve forecasting ability over different weather situations and months. For most weather conditions, the processes described herein provide accurate and stable results. The performance is constant over different months. Compared to prior art methods, the processes described herein provide more accurate and robust forecasting, and effectively utilize forecasted weather data and an LSTM model 330.

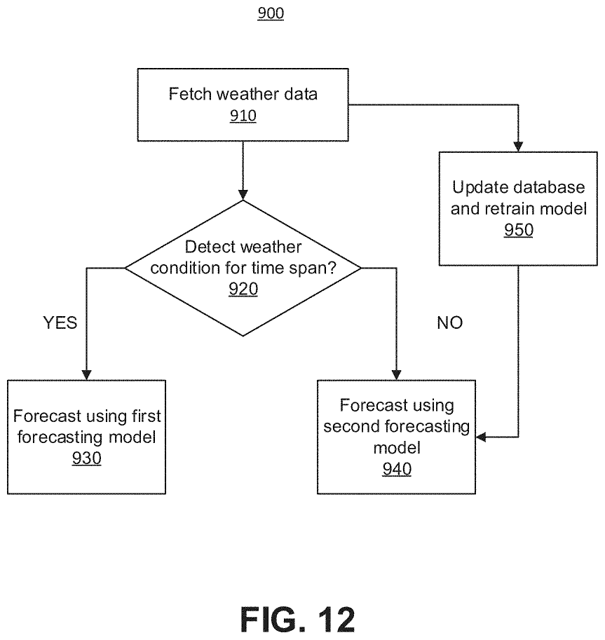

Referring now to FIG. 12, a method 900 for photovoltaic output forecasting is illustratively depicted in accordance with an embodiment of the present invention.

At block 910, system 300 fetches weather data. For example, system 300 can retrieve weather data from a local weather bureau or other source of weather forecasting data.

At block 920, system 300 determines whether a weather condition is detected for a predetermined time span. For example, system 300 can search the weather data for a number of consecutive sunny days. System 300 can identify the weather condition based on a determined accuracy of a first forecasting process (for example, based on implementing a model) exceeding a determined accuracy of a second forecasting process when the weather condition occurs.

At block 930, in response to a determination that the weather condition is detected for a predetermined time span, system 300 implements forecasting using a first forecasting process. The first forecasting process can include a persistence model 340.

At block 940, in response to a determination that the weather condition is not detected for the predetermined time span, system 300 implements forecasting using a deep learning based second forecasting process. The second forecasting process can include a trained LSTM model 330.

At block 950, the system 300 updates a database using the weather data and retrains the LSTM model 330 based on the updated database.

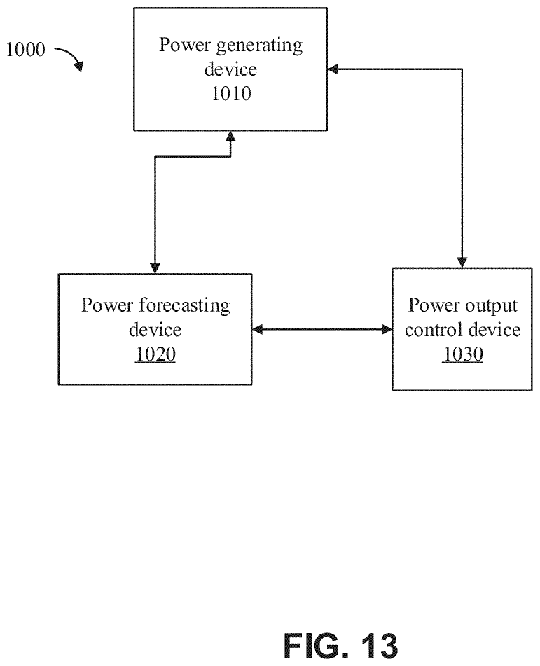

FIG. 13 is a block diagram showing an exemplary photovoltaic output forecasting 1000, in accordance with an embodiment of the present invention.

The system 1000 includes a (weather related) power generating device 1010, a power forecasting device 1020, and a power output management device 1030. Power generating device 1010, power forecasting device 1020, and power output management device 1030 can interact with each other via automated systems.

In an example embodiment, power generating device 1010 can include a power generating device whose output is affected by the weather, such as a photovoltaic device, a wind energy device, a wave energy device, a water current electrical energy generation system, a geothermal energy device, etc. Power generating device 1010 can be connected or integrated into a power grid or can operate, in some instances, as a stand-alone power generating device. Power generating device 1010 can be configured for renewable energy generation and integration.

In an example embodiment, power forecasting device 1020 can provide weather related power output forecasting (for example, photovoltaic output forecasting, wind turbine forecasting, etc.) using a hybrid model, such as in a manner described herein above with respect to FIGS. 1 to 12. Power forecasting device 1020 provides a hybrid forecasting model with a combination of a deep learning-based model (for example, a Long-short-term-memory network (LSTM), etc.) and a predictive model (for example, implementing a persistent method (PM)) to provide energy (for example, day-ahead photovoltaic (PV)) output forecasting at predetermined intervals (for example, 15-minute-interval).

In an example embodiment, power output management device 1030 can interface with power generating device 1010, power forecasting device 1020 and additional systems, external to the system 1000. For example, power output management device 1030 can receive (for example, from an additional power generating unit in a grid) and generate reports regarding projected power consumption in a grid and can adjust forecasts based on the projected power consumption.

Moreover, it is to be appreciated that various figures as described herein with respect to various elements and steps relating to the present invention that may be implemented, in whole or in part, by one or more of the elements of system 1000.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for photovoltaic (PV) output forecasting, comprising:
determining whether a weather condition that indicates a first forecasting model to have a greater accuracy than a deep learning-based forecasting model is detected in weather data for a predetermined time span;
forecasting PV output, by a processing device, using the first forecasting model in response to a determination that the weather condition is detected in the weather data for the predetermined time span; and
predicting PV output using the deep learning-based forecasting model in response to a determination that the weather condition is not detected in the weather data for the predetermined time span.

2. The method as recited in claim 1, further comprising:
identifying the weather condition based on an error rate of the first forecasting model exceeding an error rate of the deep learning-based forecasting model when the weather condition occurs.

3. The method as recited in claim 1, wherein the weather condition is an average cloud cover remaining beneath a predetermined maximum cloud cover.

4. The method as recited in claim 1, wherein the first forecasting model includes a persistence model.

5. The method as recited in claim 1, wherein the deep learning-based forecasting model includes a long-short-term-memory (LSTM) model.

6. The method as recited in claim 1, further comprising:
updating an associated database with the weather data; and
retraining the second forecasting model based at least in part on the weather data.

7. The method as recited in claim 1, wherein forecasting the PV output using the first forecasting model further comprises:
forecasting using at least one of solar radiation, temperature, relative humidity, wind speed, time index data and a calculated solar zenith angle data.

8. The method as recited in claim 1, wherein weather features of the weather data include at least one of temperature, relative humidity, wind speed, total cloud cover and solar radiation flux density.

9. The method as recited in claim 1, further comprising:
tuning, by the processor device, the deep learning-based forecasting model based on trial and error.

10. The method as recited in claim 1, further comprising:
selecting features for a training set for the deep learning-based forecasting model using a root mean squared Euclidean distance difference (RMSEDD):
$${RMSEDD}_{i} = \frac{\sqrt{{\sum }_{{d}^{′} = d}^{N} {\sum }_{d = 1}^{{d}^{′}} {( ED ( p , d , {d}^{′} ) - ED ( {v}_{i} , d , {d}^{′} ) )}^{2}}}{\frac{1}{2} N ( N - 1 )} ,$$
wherein ED (x, d, d′) measures a Euclidean distance (ED) between day d and d′ based on normalized variables x, which include normalized iₜₕ feature vᵢ and normalized PV output p, t indicates a data point and N indicates a number of training days.

11. The method as recited in claim 1, further comprising:
measuring a prediction accuracy including daily normalized root-mean-square deviation (nRMSE):
$$nRMSE = \frac{100}{{P}_{C}} \sqrt{{\sum }_{t = 1}^{96} {( {\hat{P}}_{t} - {P}_{t} )}^{2}} ,$$
wherein PC is the capacity of a PV site, and P\hat{ }t and Pt are a forecasted and recorded PV output at data point t.

12. A computer system for photovoltaic (PV) output forecasting, comprising:
a processor device operatively coupled to a memory device, the processor device being configured to:
determine whether a weather condition that indicates a first forecasting model to have a greater accuracy than a deep learning-based forecasting model is detected in weather data for a predetermined time span;
forecast PV output using the first forecasting model in response to a determination that the weather condition is detected in the weather data for the predetermined time span; and
predict PV output using the deep learning-based forecasting model in response to a determination that the weather condition is not detected in the weather data for the predetermined time span.

13. The system as recited in claim 12, wherein the processor device is further configured to:
identify the weather condition based on an error rate of the first forecasting model exceeding an error rate of the deep learning-based forecasting model when the weather condition occurs.

14. The system as recited in claim 12, wherein the first forecasting model includes a persistence model.

15. The system as recited in claim 12, wherein the deep learning-based forecasting model includes a long-short-term-memory (LSTM) model.

16. The system as recited in claim 12, wherein the processor device is further configured to:
update an associated database with the weather data; and
retrain the second forecasting model based at least in part on the weather data.

17. The system as recited in claim 12, wherein weather features of the weather data include at least one of temperature, relative humidity, wind speed, total cloud cover and solar radiation flux density.

18. The system as recited in claim 12, wherein the processor device is further configured to:
select important features for a training set using a root mean squared Euclidean distance difference (RMSEDD):
$${RMSEDD}_{i} = \frac{\sqrt{{\sum }_{{d}^{′} = d}^{N} {\sum }_{d = 1}^{{d}^{′}} {( ED ( p , d , {d}^{′} ) - ED ( {v}_{i} , d , {d}^{′} ) )}^{2}}}{\frac{1}{2} N ( N - 1 )} ,$$
wherein ED (x, d, d′) measures a Euclidean distance (ED) between day d and d′ based on normalized variables x, which include normalized iₜₕ feature vᵢ and normalized PV output p, t indicates a data point and N indicates a number of training days.

19. The system as recited in claim 12, wherein the processor device is further configured to:
measure a prediction accuracy including daily normalized root-mean-square deviation (nRMSE):
$$nRMSE = \frac{100}{{P}_{C}} \sqrt{{\sum }_{t = 1}^{96} {( {\hat{P}}_{t} - {P}_{t} )}^{2}} ,$$
wherein PC is the capacity of a PV site, and P\hat{ }t and Pt are a forecasted and recorded PV output at data point t.

20. A computer program product for photovoltaic (PV) output forecasting, the computer program product comprising a non-transitory computer readable storage medium having program instructions embodied therewith, the program instructions executable by a computing device to cause the computing device to perform the method comprising:
determining whether a weather condition that indicates a first forecasting model to have a greater accuracy than a deep learning-based forecasting model is detected in weather data for a predetermined time span;
forecasting PV output, by a processing device, using the first forecasting model in response to a determination that the weather condition is detected in the weather data for the predetermined time span; and
predicting PV output using the deep learning-based forecasting model in response to a determination that the weather condition is not detected in the weather data for the predetermined time span.
